(19) United States
(12) Patent Application Publication
(10) Pub. No.: US 2026/0138830 A1
(43) Pub. Date: May 21, 2026

(54) CHUTE COVER FOR DISPENSER

(71) Applicant: OPTUM, INC., Minnetonka, MN (US)

(72) Inventors: Stephen Charles BOVENIZER, Deltona, FL (US); Albo David DOMINGUEZ GONZALEZ, Oviedo, FL (US)

(21) Appl. No.: 19/072,797

(22) Filed: Mar. 6, 2025

Related U.S. Application Data
(60) Provisional application No. 63/721,047, filed on Nov. 15, 2024.

(51) Int. Cl. B65G 11/20

(52) U.S. Cl. CPC B65G 11/20

(57) ABSTRACT

Embodiments of the present disclosure relate to a chute cover mechanism for a dispenser. An example chute cover mechanism comprises a slide cover and a chute cover. The chute cover comprises a bias mechanism and a channel and is attached to the dispenser to position the chute cover over an entry void of a dispensing chute. The slide cover is positioned within the channel and includes a protruding member positioned to receive a force from a dispensing reservoir to transition the chute cover mechanism from an engaged state to a disengaged state as the dispensing reservoir is inserted into the dispenser. In the engaged state, the slide cover is positioned to at least partially cover the entry void of the dispensing chute. In the disengaged state, the slide cover is positioned to expose the entry void of the dispensing chute.

### CROSS REFERENCE TO RELATED APPLICATIONS

This application claims the benefit of and priority to U.S. Application No. 63/721,047, filed Nov. 15, 2024, entitled “CHUTE COVER FOR PILL DISPENSER,” the disclosure of which is incorporated herein in its entirety.

### BACKGROUND

In various domains, mechanical dispensers, such as automatic, semiautomatic, or manual dispensing machinery, may be used to dispense objects from a reservoir to a downstream container. Among other components, such machines typically comprise a dispensing reservoir, a dispensing chute, and mechanical components to dispense objects from the dispensing reservoir, through the dispending chute, and to a downstream container. During operation, dispensing reservoirs may be removed, replaces, and/or refilled to continuously dispense objects through the mechanical dispenser. While reservoir is removed from a mechanical dispenser, the dispending chute in some machines may be exposed to an outside environment with may leave the dispensing chute susceptible to foreign objects, debris, and/or other contaminant that, if undetected, may contaminate containers downstream of the dispensing chute.

### BRIEF DESCRIPTION OF THE DRAWINGS

FIG. 1 provides a top perspective view of a chute cover mechanism in accordance with some embodiments of the present disclosure.

FIG. 2 provides a side view of a chute cover mechanism in accordance with some embodiments of the present disclosure.

FIG. 3 provides a first perspective view of a chute cover in accordance with some embodiments of the present disclosure.

FIG. 4 provides a second perspective view of a chute cover in accordance with some embodiments of the present disclosure.

FIG. 5 provides a right-side view of a chute cover in accordance with some embodiments of the present disclosure.

FIG. 6 provides a left-side view of a chute cover in accordance with some embodiments of the present disclosure.

FIG. 7 provides a front view of a chute cover in accordance with some embodiments of the present disclosure.

FIG. 8 provides a top view of a chute cover in accordance with some embodiments of the present disclosure.

FIG. 9 provides a first perspective view of a slide cover in accordance with some embodiments of the present disclosure.

FIG. 10 provides a second perspective view of a slide cover in accordance with some embodiments of the present disclosure.

FIGS. 11A-B provide, respectively, a left-side view and a right-side view of a slide cover in accordance with some embodiments of the present disclosure.

FIG. 12 provides a front view of a slide cover in accordance with some embodiments of the present disclosure.

FIG. 13 provides a top view of a slide cover in accordance with some embodiments of the present disclosure.

FIG. 14 shows a workflow 1400 for installing a chute cover mechanism in accordance with some embodiments of the present disclosure.

FIG. 15 provides a flowchart of an example process for operating a chute cover mechanism in accordance with some embodiments of the present disclosure.

### DETAILED DESCRIPTION

Various embodiments of the present disclosure address challenges with mechanical dispensers, such as those described herein, by introducing a chute cover mechanism that may automatically cover at least a portion of a dispensing chute to prevent introduction of contaminants. The chute cover mechanism may be attached to at least a portion of a compatible mechanical dispenser to at least partially cover the dispensing chute without inhibiting the flow of objects from the dispensing reservoir to the dispensing chute. The chute cover mechanism may be tailored to any mechanical dispenser, comprising those in various contexts, such as pharmacy pill dispensers, and/or the like. In a pharmacy use case, for example, the chute cover mechanism may be compatible with a Yuyama EV-54 semi-automatic vial filling machine that may be used by pharmacists to selectively dispense various medications from dedicated reservoirs and/or chutes to fill various prescriptions. In such a context, the chute cover mechanism may be configured to prevent foreign objects from entering a dispensing chute while a container (e.g., pill reservoir) associated with a dispensing chute is removed from a pill dispenser. In doing so, the chute cover mechanism may prevent foreign objects, such as different pill types, mechanical components (e.g., screws), and/or the like, from entering a vial underneath a dispensing chute. In do so, when used in a pharmaceutical setting the chute cover mechanism may improve patient safety and medication order fulfillment. Similar improvements may be achieved in other settings by converting the chute cover mechanism to a particular mechanical dispenser. The chute cover mechanism, for example, may be provided as an add on to any existing mechanical dispenser, comprising existing pill dispensers, and other product dispensers, without requiring structural or functional modifications to the dispensers themselves. For example, the chute cover mechanism may comprise one or more clips that enable the mechanism to be secured to existing portions of a mechanical dispenser without requiring permanent modification of the mechanical dispenser via cutting, drilling, fasteners, and/or the like. In this manner, existing mechanical dispensers may be quickly and efficiently retrofitted to improve safety, throughput, and/or other operational characteristics of any mechanical dispenser.

More particularly, some embodiments of the present disclosure provide mechanisms, such as a chute cover mechanism, for augmenting mechanical dispensers (e.g., automatic, semi-automatic, manual) to improve the fulfillment accuracy and speed of the augmented systems. An example mechanical dispenser may comprise one or more pairs of dispensing reservoirs and dispensing chutes. A respective dispensing chute may be configured to receive and dispense an object of a particular object type (e.g., a medication) from a single paired dispensing reservoir. Thus, a paired dispensing reservoir and dispensing chute may be configured to dispense a single object type. Periodically, a dispensing reservoir may be removed from the mechanical dispenser for refilling, maintenance, and/or the like. In such instances, cross-contamination of objects (e.g., different medications) into the exposed dispensing chute may occur. For example, in a pharmaceutical use case, a medication or other foreign object from another pill reservoir or part of a pill dispenser could make its way into a dispensing chute, such that manual inspection is required to detect and remove the foreign object before operating a pill dispenser after refilling a pill reservoir.

Some of the techniques of the present disclosure provide a chute cover mechanism that is compatible with a mechanical dispenser and configured to at least partially cover an entry void of a dispensing chute in between the dispensation of object from a dispensing reservoir. The chute cover mechanism, for example, may be mechanically connected to the dispensing chute and may be disengaged while a dispensing reservoir is installed within the mechanical dispenser and engaged to at least partially cover the entry void of the dispensing chute while the dispensing reservoir is uninstalled within the mechanical dispenser. For instance, the chute cover mechanism may be attached to the dispensing chute and aligned with a movement path of an associated dispensing reservoir such that the chute cover mechanism automatically opens as the dispensing reservoir is installed and automatically closes as the dispensing reservoir is removed from the mechanical dispenser. In this way, the chute cover mechanism may prevent the introduction of any foreign object (not within a dispensing reservoir) to a dispensing chute of a mechanical dispenser without manual inspection of the dispensing chute itself. In some embodiments, the chute cover mechanism may be attached to the dispenser without permanently removing existing components of the dispenser and without plastic deformation of the dispenser (e.g., drilling, cutting, warping, and/or the like).

In some embodiments, the chute cover mechanism comprises a chute cover, a slide cover, and/or a bias mechanism. The chute cover may be installed over the entry void of the dispensing chute and may house the slide cover in a moveable position such that the slide cover may be reversibly translated over the dispensing chute, thereby occluding the entry void and preventing entry of foreign objects. The bias mechanism may apply a force to the slide cover to bias the slide cover toward translating over the entry void. While the dispensing reservoir is inserted into the mechanical dispenser, the mechanical dispenser may oppose the force of the bias mechanism and, in doing so, prevent the slide cover from translating over the dispensing chute. As the dispensing reservoir is removed from the mechanical dispenser, the bias of the bias mechanism may advance the slide cover over the dispensing chute. In this manner so, the chute cover mechanism may prevent entry of foreign objects into the dispensing chute, which may improve safety (e.g., in a pharmacy setting) and order fulfillment accuracy.

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### I. Example Chute Cover Mechanism

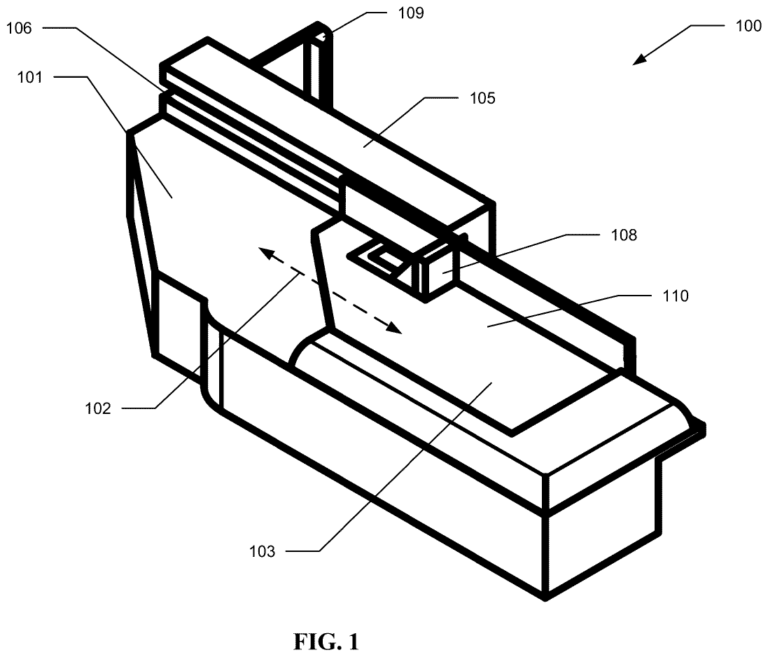

FIG. 1 provides a top perspective view of a chute cover mechanism 100 (“mechanism” 100). In various embodiments, the mechanism 100 comprises a chute cover 101 and a slide cover 103. In some embodiments, the chute cover 101 and the slide cover 103 comprise one or more plastic materials. For example, the chute cover 101 and the slide cover 103 may comprise one or more nylon materials. In some examples, the chute cover 101 and/or the slide cover 103 comprise non-shedding, self-lubricating materials. In doing so, the chute cover 101 and the slide cover 103 may avoid introduction of particles, debris, and/or the like into a dispenser and objects dispensed therefrom. In various embodiments, the chute cover 101 and the slide cover 103 comprise inert materials. For example, the chute cover 101 and the slide cover 103 may comprise one or more food grade plastic materials. In this manner, the chute cover 101 and the slide cover 103 may be nonreactive with other components of the dispenser and objects housed therewithin. In some embodiments, the chute cover 101 and the slide cover 103 comprise one or more non-shedding, self-lubricating materials.

In some embodiments, the term “dispenser” refers to any system or mechanism configured to distribute an amount of objects to a user via movement of the objects from a dispensing reservoir into a dispensing chute. In some embodiments, the dispenser is configured to operate semi-automatically. For example, in a pharmaceutical context, the dispenser may be commanded to dispense a prescribed amount of one of a plurality of types of medication. In such contexts, the dispenser may automatically distribute the prescribed amount of the designated medication from a dispensing reservoir into an entry void of a dispensing chute that is associated with the dispensing reservoir. The user may access or engage an exit void of the dispensing chute to load the prescribed amount of the designated medication into a container, such as a vial.

In some embodiments, the term “dispensing reservoir” refers to any system or mechanism configured to hold a volume of objects such that various amounts of the objects may be delivered from the contained volume into a dispensing chute. In various embodiments, a dispensing reservoir is extractable from a dispenser such that the dispensing reservoir may be removed and refilled with additional objects. For example, in a pharmaceutical context, a dispensing reservoir may be a removable cannister configured to contain a medication and dispense prescribed amounts of the medication into the entry void of a dispensing chute. In some embodiments, an outlet of the dispensing reservoir is located proximate to the entry void of the dispensing chute such that objects may be dropped from the outlet into the entry void. Alternatively, in some embodiments, the outlet of the dispensing reservoir is located apart from the entry void of the dispensing chute, and the dispenser comprises means of receiving objects from the outlet of the dispensing reservoir and advancing the objects into the entry void of the dispensing chute.

In some embodiments, the term “dispensing chute” refers to any mechanism for distributing a number of objects out of a dispenser. For example, a dispensing chute may comprise an inclined tubular structure comprising an entry void through which objects are received from a dispensing reservoir and an exit void through which objects are dispensed out of the dispenser under gravity. As another example, a dispensing chute may comprise a rotatable plane configured to receive objects and undergo a partial or full rotation to direct the objects out of the dispenser under gravity. In various embodiments, a dispensing chute comprises a release mechanism configured to control movement of objects out of the exit void of the dispensing chute. For example, a release mechanism may comprise a door and a spring configured to bias the door to a closed position in which the exit void is occluded, preventing movement of objects out of the dispensing chute. A user may transition the door to an open position via manual operation or placement of a container against a lever of the release mechanism. In doing so, the objects may be allowed to translate out of the dispensing chute under gravity.

In some embodiments, the term “foreign object” refers to any article or substance that is not intended for dispensing by a user. For example, a foreign object may comprise a screw, machine component, debris, other object and/or the like. As another example, a foreign object may be an object from the dispensing reservoir that failed to dispense in accordance with a previous dispensing operation.

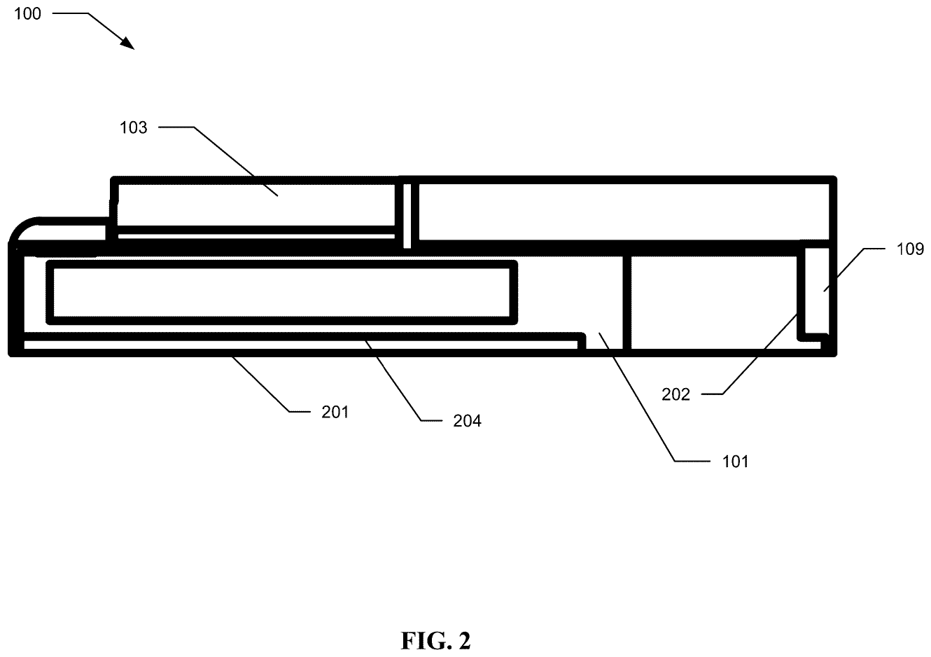

In various embodiments, the mechanism 100 is configured to attach to a portion of a dispenser such that the chute cover 101 is positioned over a dispensing chute of the dispenser. For example, the dispenser may comprise a dispensing reservoir vertically arranged over a dispensing chute such that objects may be dispensed from an outlet of the dispensing reservoir into an entry void of the dispensing chute under gravity. The mechanism 100 may be attached to the dispenser such that the mechanism 100 is positioned between the outlet of the dispensing reservoir and the entry void of the dispensing chute. In this manner, the mechanism 100 may be engaged and disengaged to occlude or expose the entry void of the dispensing chute in accordance with removal or insertion of the dispensing reservoir. In some embodiments, the mechanism 100 is configured to secure to the dispenser via clips, adhesives, magnets, and/or the like. For example, as shown in FIGS. 1 and 2, respectively, the chute cover 101 may comprise a first clip 109 and a second clip 201 that connect to internal portions of the dispenser to secure the mechanism 100 between the outlet of the dispensing reservoir and the entry void of the dispensing chute. For example, the first clip 109, the second clip 201, and/or the like may attach to one or more portions of the dispenser to position the chute cover 101 over an entry void of a dispensing chute.

In various embodiments, the chute cover 101 slidably receives the slide cover 103 such that the slide cover 103 may translate longitudinally along the chute cover 101. For example, the slide cover 103 may be forward and reverse-translate along a longitudinal direction (indicium 102). In FIG. 1, the slide cover 103 is shown in a forward-translated position relative to the chute cover 101. The forward-translated position may be referred to herein as an “engaged state.” In the engaged state, the slide cover 103 may at least partially cover an entry void of a dispensing chute located beneath the chute cover 101. In doing so, the slide cover 103 may prevent movement of foreign objects through the entry void of the dispensing chute. The slide cover 103 may translate away from the position shown in FIG. 1 and, in doing so, expose the entry void of the dispensing chute such that objects may be dispensed from the outlet of the dispensing reservoir into dispensing chute. In such contexts, the reverse-translated position may be referred to herein as a “disengaged state.”

In some embodiments, the chute cover 101 comprises a bias mechanism 105 configured to bias the slide cover 103 toward the engaged state. For example, the bias mechanism 105 may apply a force to the slide cover 103 and, in doing so, bias the slide cover 103 to translate toward the position shown in FIG. 1.

In some embodiments, the bias mechanism 105 comprises a slot 106 configured to house a bias element (not shown). In some embodiments, the bias element comprises a spring attached within the slot 106. In some embodiments, the bias element comprises one or more elastic bands attached within the slot 106. In some embodiments, the bias element comprises a first magnetic element, and the slot 106 comprises a second magnetic element positioned such that the first magnetic element and the second magnetic element repulse one another. For example, a side of the second magnetic element that faces a side of the first magnetic element may comprise a polarity that matches a polarity of the first magnetic element. In some embodiments, the first magnetic element, the second magnetic element, and/or the like comprise a circular cross-section. Alternatively, in some examples, the first magnetic element, the second magnetic element, and/or the like comprise a rectangular cross-section. In some embodiments, the bias mechanism 105 comprises a rectangular body that protrudes from a surface of the chute cover 101. The rectangular body may comprise the elements of the bias mechanism 105, such as the slot 106 and a bias element.

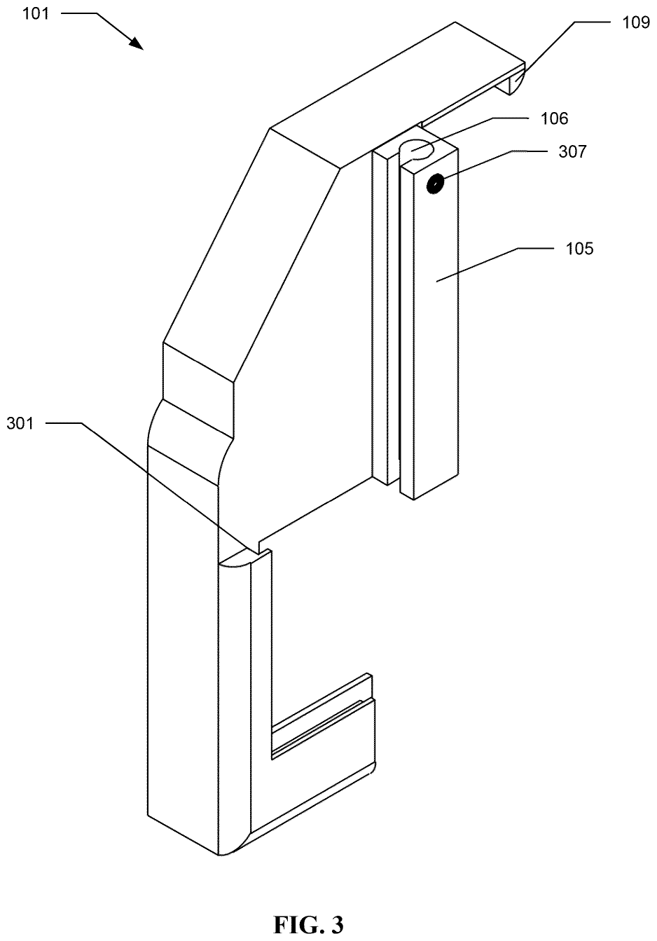

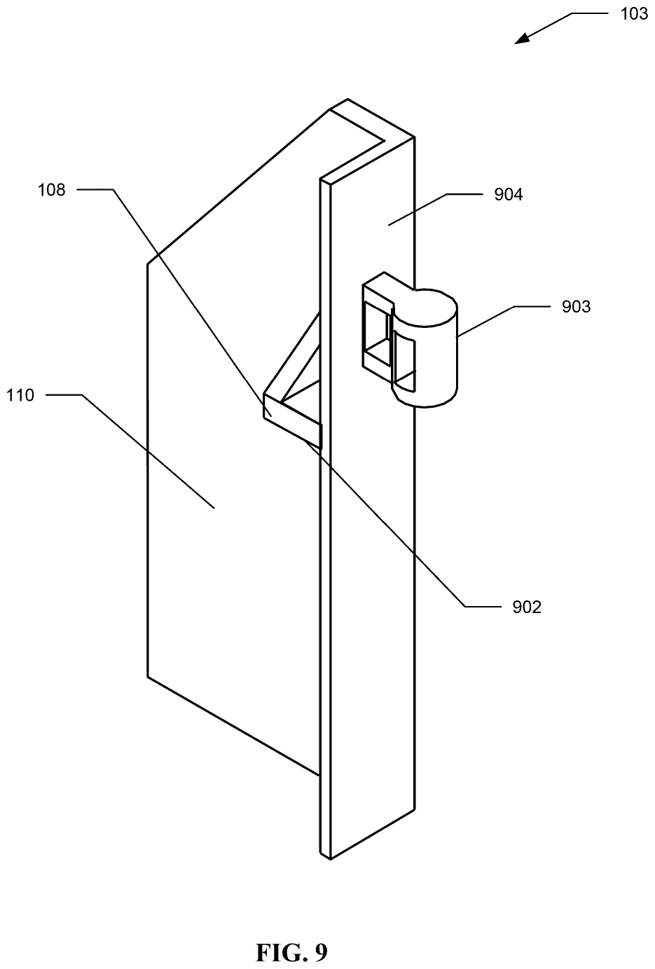

In various embodiments, the slot 106 receives a portion of the slide cover 103. For example, the slot 106 may receive a member 903 (FIG. 9). In some embodiments, the bias mechanism 105 comprises a spring that extends along the slot 106 and contacts the received portion of the slide cover 103. In doing so, the spring may apply a force to the slide cover 103 and, thereby, bias the slide cover 103 to translate toward the position shown in FIG. 1. In some embodiments, the bias mechanism 105 comprises a retaining pin 307 (FIG. 3) that secures the spring within the slot 106. For example, the retaining pin 307 may anchor the spring to and end of the slot 106. Alternatively, in some embodiments, one or more elastic bands extend across the slot 106 such that the member 903 contacts the elastic band. As a dispensing reservoir is inserted into the dispenser, the member 108 may receive a force from the dispensing reservoir, which may cause the member 903 to traverse along the slot 106 and apply a force to the elastic band. The elastic bands may elastically deform as the member 903 translates along the slot 106. In this manner, the elastic bands may generate and apply a bias force to the member 903. As the dispensing reservoir is removed from the dispenser, the bias force may cause the member 903 to reverse translate along the slot 106 to transition the chute cover mechanism to an engaged state.

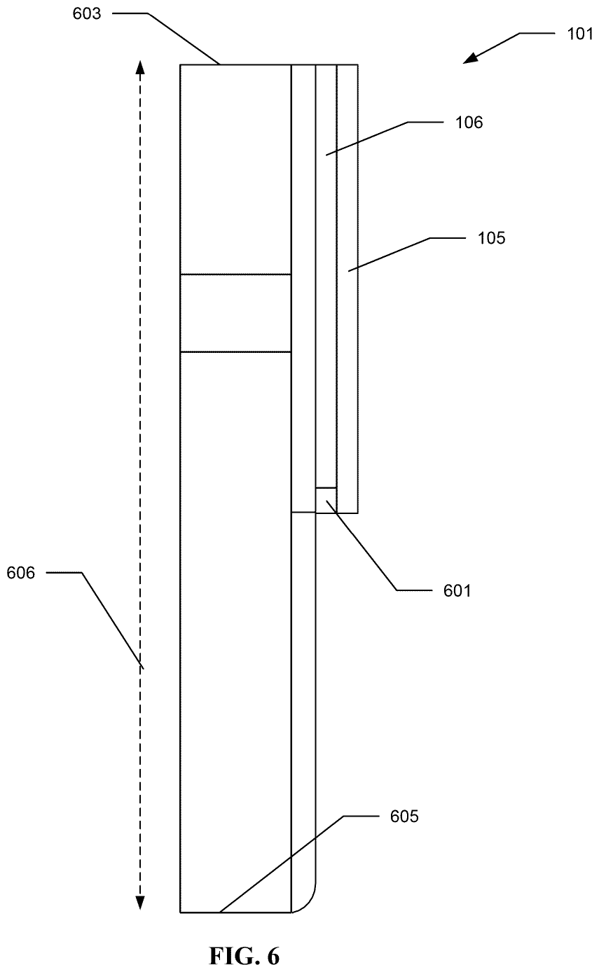

Alternatively, in some embodiments, the slot 106 comprises a stationary magnetic element and the member 903 comprises a magnetic element that repulses, and is repulsed by, the stationary magnetic element. For example, as the dispensing reservoir is inserted into the dispenser, the member 903 may translate toward the stationary magnetic element, and a bias force may be generated and applied to the magnetic elements via repulsion. As the dispensing reservoir is removed, the bias force may cause the member 903 to reverse translate along the slot 106. In some embodiments, the slot 106 comprises a stop 601 (FIG. 6) that limits extension of the spring, the magnetic element, and/or the like, and, in doing so, limit the forward translation of the slide cover 103.

In various embodiments, the slot 106 comprises a circular cross-section. Alternatively, in some embodiments, the slot 106 comprises a rectangular cross-section. In some embodiments, the slot 106 comprises a constant diameter. Alternatively, in some embodiments, the slot 106 comprises a tapering diameter. For example, the slot 106 may taper in diameter toward the stop 601, which may further constrain forward translation of the slide cover 103 within a desired range.

In some embodiments, the slide cover 103 comprises a member 108 that protrudes from a surface 110 of the slide cover such that the member 108 is positioned receive a force from a dispensing reservoir as the dispensing reservoir is inserted into the dispenser. For example, the member 108 may project outward from the mechanism 100 into a movement pathway of the dispensing reservoir. In doing so, the member 108 may receive a force from that dispensing reservoir that opposes the biasing (e.g., spring force, magnetic force, and/or elastic force) from the bias mechanism 105. In some embodiments, the member 108 enables the slide cover 103 to be transitioned to the disengaged state via insertion of the dispensing reservoir into the dispenser. For example, as the dispensing reservoir is inserted, the force applied to the member 108 may cause the slide cover 103 to reverse translate away from the position shown in FIG. 1, thereby exposing the entry void of the dispensing chute. The movement of the slide cover 103 may compress a spring, stretch an elastic band, or compress a magnetic arrangement, thereby biasing the bias mechanism 105 to re-engage the slide cover 103 upon subsequent removal of the dispensing reservoir. In some embodiments, the member 108 is referred to as a “slide pusher.”

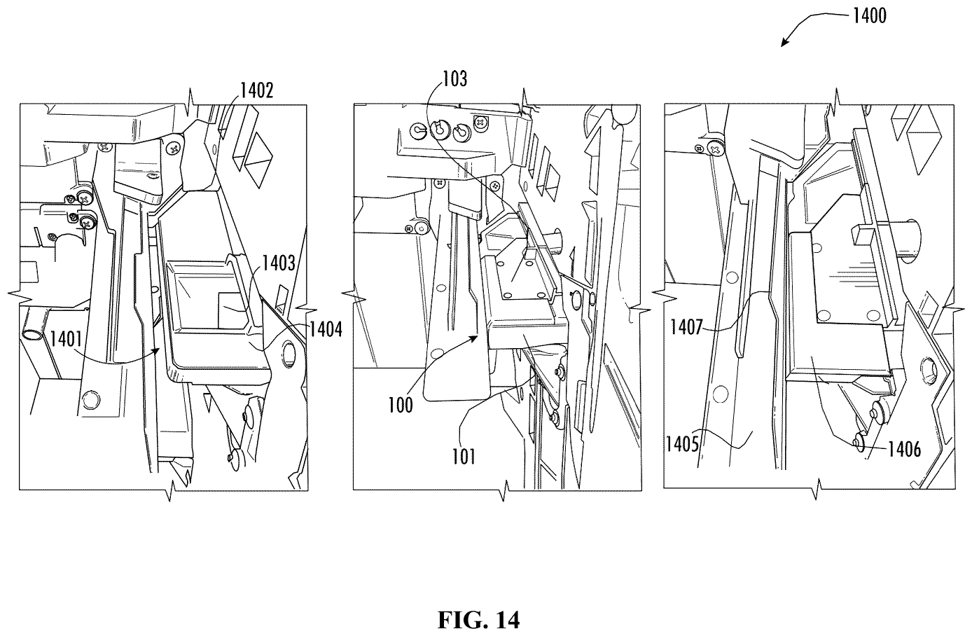

FIG. 2 provides a side view of a chute cover mechanism 100. In some embodiments, the chute cover 101 comprises a first clip 109 configured to attach to a first portion of a dispensing chute. In some embodiments, the chute cover 101 comprises a second clip 201 configured to attach to a second portion of the dispensing chute. In some embodiments, the first clip 109 is oriented orthogonal to the second clip 201. For example, the first clip 109 may comprise a lip 202 that is oriented orthogonal to a lip 204 of the second clip 201. In some embodiments, the first clip 109 is configured to attach the chute cover 101 to a rear portion of a dispensing chute and the second clip 201 is configured to attach the chute cover 101 to a side portion of the dispensing chute. Additional examples aspects of attaching the mechanism 100 to a dispensing chute are shown in FIG. 14 and described herein.

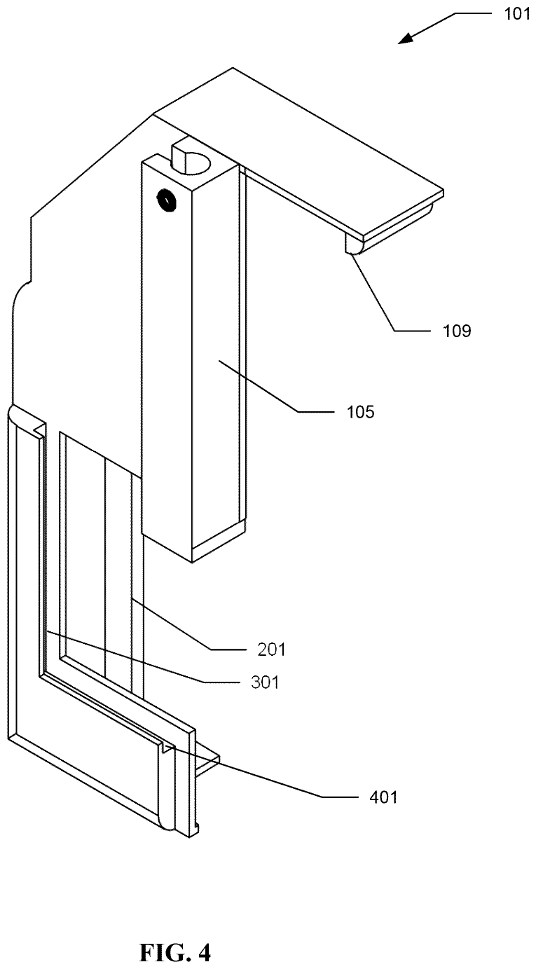

FIG. 3 provides a first perspective view of a chute cover 101. In some embodiments, the chute cover 101 comprises a channel 301 positioned to receive at least a portion of a slide cover to constrain translation of the slide cover 103 along a plane extending parallel to a surface of the chute cover 101. For example, the channel 301 may receive a portion of the slide cover 103. In some embodiments, the channel 301 comprises a stop 401 (FIG. 4) configured to limit the forward translation of the slide cover under the force of the bias mechanism 105. In some embodiments, the channel 301 is configured to limit the forward translation of the slide cover such that, upon engagement, the slide cover translates to a position that at least partially covers an entry void of a dispensing chute. In some embodiments, the elements of the chute cover 101 are integrally formed. For example, the chute cover 101 may be integrally formed via injection molding, additive manufacturing, and/or the like.

FIG. 4 provides a second perspective view of a chute cover 101. As shown, the channel 301 may comprise a stop 401 configured to halt translation of a slide cover such that, in the engaged state, the slide cover is maintained in an occluding position by the stop 401 and the force of the bias mechanism 105. In such contexts, the occluding position may refer to an orientation over the entry void of a dispensing chute that prevents entry of foreign objects into the dispensing chute.

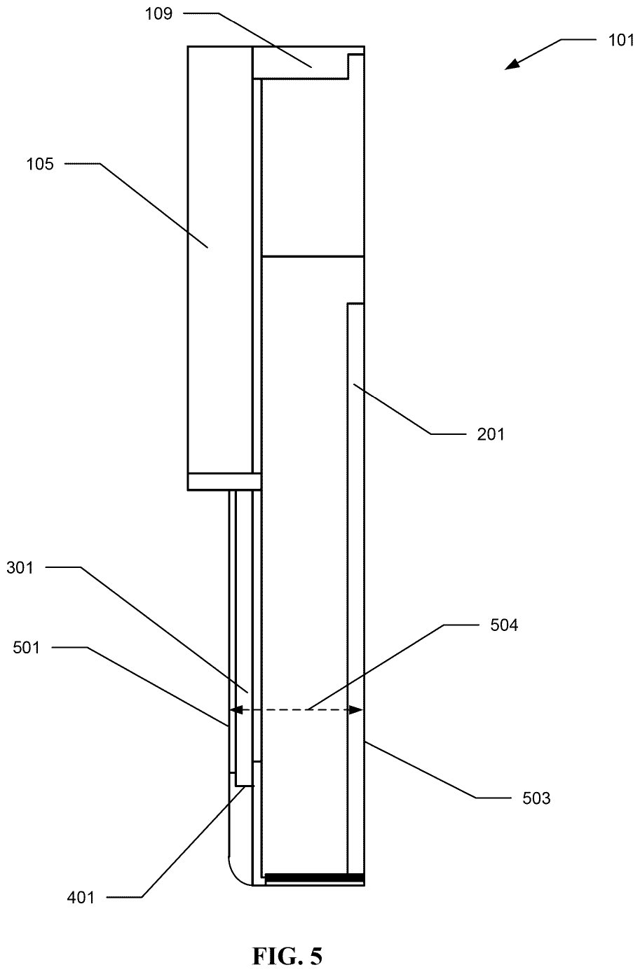

FIGS. 5-9 depict a right-side, left-side, front, and top views of the chute cover 101. FIG. 5, for example, depicts a right-side view of a chute cover 101 comprising the bias mechanism 105, the first clip 109, the second clip 201, the channel 301, and the stop 401. In some embodiments, the channel 301 comprises a top surface 501. In some embodiments, the chute cover 101 comprises a bottom surface 503 positioned opposite to the top surface 501. In some embodiments, between the top surface 501 and the bottom surface 503, the chute cover 101 comprises a thickness 504 of 20.69-22.29 mm. For example, the thickness 504 may be 21.49 mm. In some embodiments, the top surface 501 protrudes from the chute cover 101 to align the top surface 501 with a top surface of a reservoir guide of the dispenser. In this manner, the bottom surface of the dispensing reservoir may slide over a common plane defined by the top surface 501 and the top surface of the reservoir guide. As another example, FIG. 6 depicts a left-side view of a chute cover 101 comprising the bias mechanism 105, the slot 106, and the stop 601. In some embodiments, the chute cover 101 comprises a first end 603 and a second end 605 opposite the first end 603. In some embodiments, between the first end 603 and second end 605, the chute cover 101 comprises a length 606 of 101.5-103.13 mm. For example, the length 606 may be 102.3 mm.

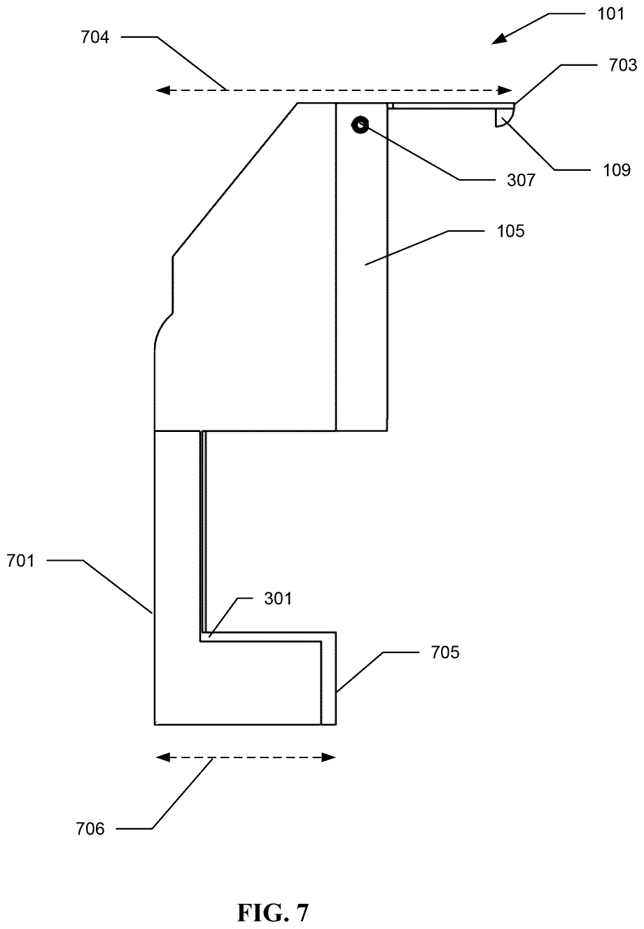

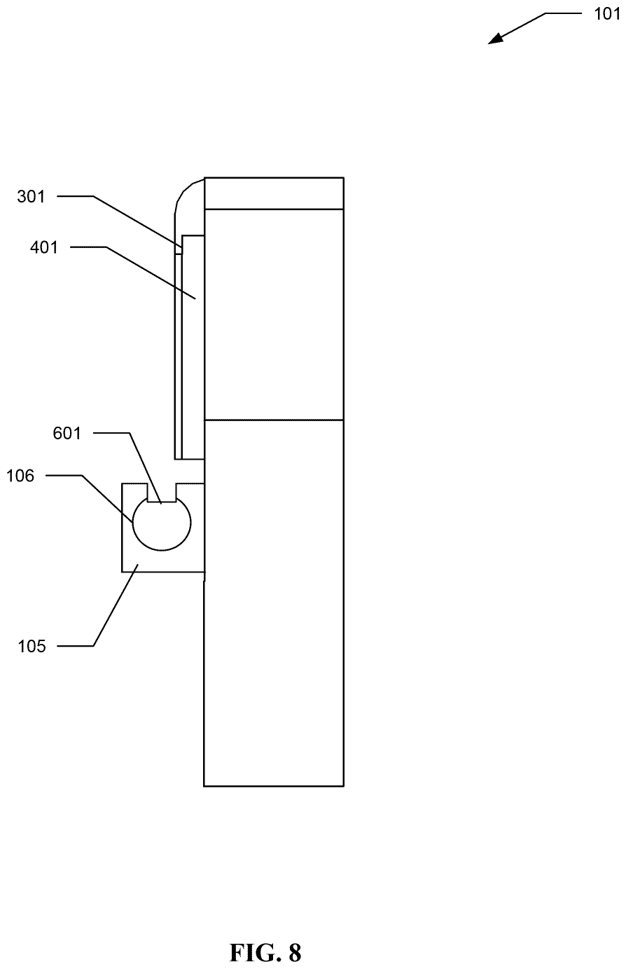

FIG. 7 depicts a front view of the chute cover 101 comprising the bias mechanism 105, the retaining pin 307, the first clip 109, and the channel 301. In some embodiments, the chute cover 101 comprises a first side surface 701 that is positioned opposite from an edge 703 of the first clip 109. In some embodiments, between the first side surface 701 and the edge 703, the chute cover 101 comprises a first width 704 of 58.32-59.92 mm. For example, the first width 704 may be 59.12 mm. In some embodiments, the chute cover 101 comprises a second side surface 705 positioned between the first side surface 701 and the first clip 109. In some embodiments, the second side surface 705 defines an edge of the channel 301. In some embodiments, between the first side surface 701 and the second side surface 705, the chute cover 101 comprises a second width 706 of 28.91-30.51. For example, the second width 706 may be 29.71 mm. FIG. 8 depicts a top view of a chute cover 101 comprising the bias mechanism 105, the slot 106, the stop 601, the channel 301, and the stop 401.

FIG. 9 provides a first perspective view of a slide cover 103. In various embodiments, the slide cover 103 comprises a surface 110 that is configured to at least partially cover an entry void of a dispensing chute in response to removal of a dispensing reservoir associated with the dispensing chute. For example, when the mechanism 100 (FIG. 1) is in an engaged state, the surface 110 may occupy a footprint of the entry void such that movement of foreign objects through the entry void is prevented. In some embodiments, the slide cover 103 is configured to be received within a portion of a chute cover 101 such that the slide cover 103 may translate along a plane extending across a length of the chute cover 101. In this manner, the surface 110 may be translated forward and backward to occlude and expose the entry void of the dispensing chute.

In some embodiments, the slide cover 103 comprises a member 903 that protrudes from a second surface 904 of the slide cover. In some embodiments, the surface 110 and the second surface 904 are orthogonal. In some embodiments, the member 903 is positioned within a slot 106 of the chute cover 101 to apply a force to the bias element of the bias mechanism 105 as a dispensing reservoir is inserted into the dispenser. In some embodiments, the member 903 comprises a cylindrical shape. Alternatively, or additionally, in some embodiments, the member 903 comprises a rectangular shape. In various embodiments, the member 903 is positioned within the slot receive a bias force from the bias mechanism 105 (e.g., via a spring, magnetic arrangement, elastic band, and/or the like). The bias force may cause the member 903 to translate along the slot 106, thereby causing forward translation of the slide cover 103 (e.g., in accordance with removal of a dispensing reservoir).

In various embodiments, the member 108 is configured to receive a force from the dispensing reservoir as the dispensing reservoir is inserted into the dispenser. In some embodiments, the member 108 comprises a surface 902 that is orthogonal to the surface 110. In some embodiments, the orthogonal arrangement enables a dispensing reservoir to slide over the surface 110 until contacting the member 108. In some embodiments, the force received by the member 108 causes the slide cover 103 to reverse translate (e.g., the member 903 reverse translates along the slot 106 away from the stop 601). The reverse translation of the slide cover 103 may expose the entry void of the dispensing chute to a bottom surface of the dispensing reservoir such that objects may pass from the dispensing reservoir into the dispensing chute.

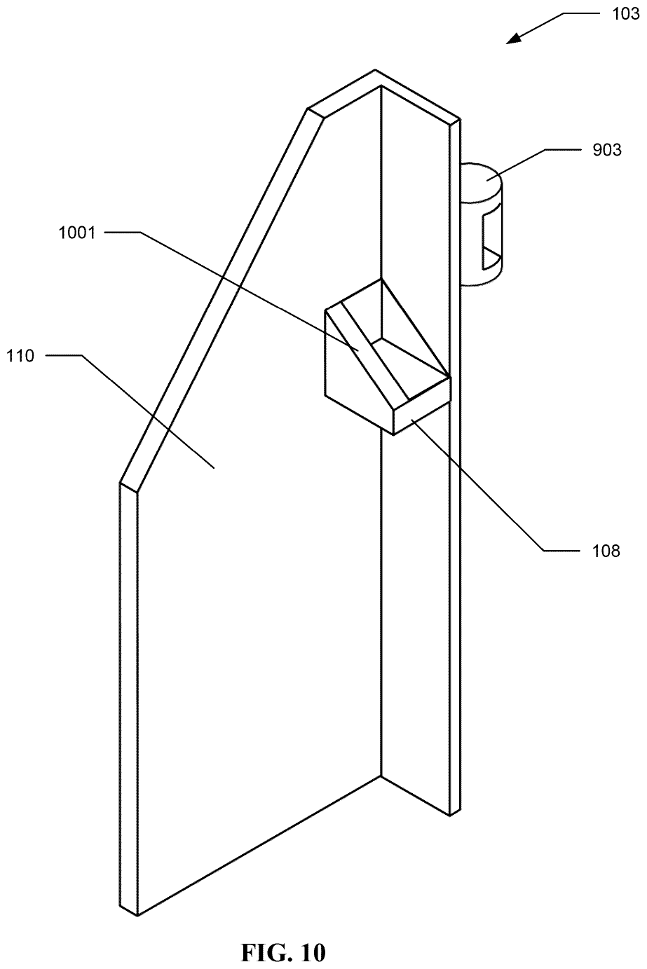

FIG. 10 provides a second perspective view of a slide cover 103. In some embodiments, the member 108 comprises an angular support 1001 configured to buttress the member 108 against forces applied by a dispensing reservoir during insertion. In some embodiments, the elements of the slide cover 103 are integrally formed. For example, the slide cover 103 may be integrally formed via injection molding, additive manufacturing, and/or the like.

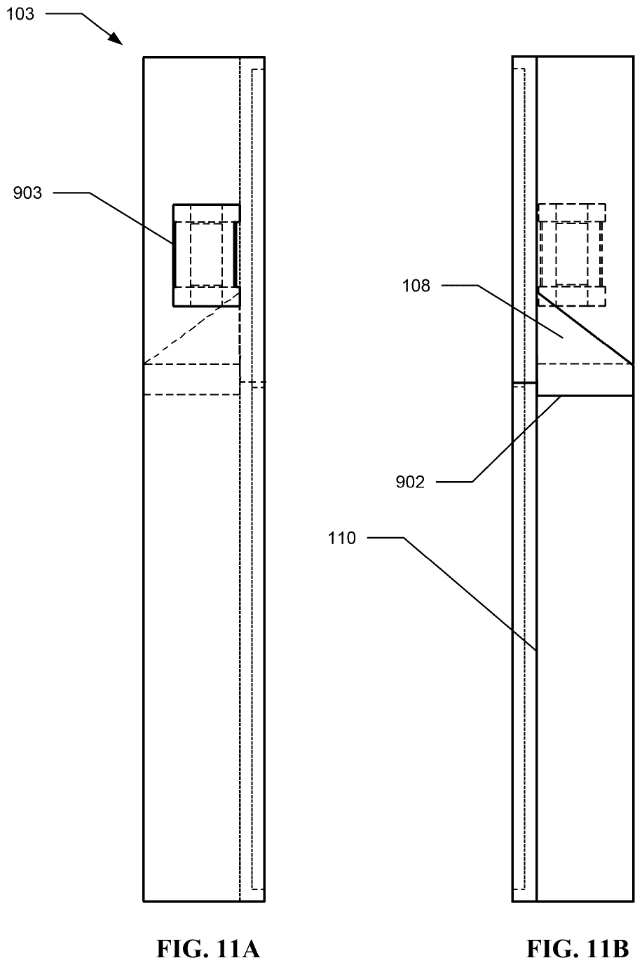

FIGS. 11A-B provide, respectively, a left-side view and a right-side view of a slide cover 103. For example, FIG. 11A depicts the member 903, and FIG. 11B depicts the member 108, the surface 110, and the surface 902 of the member 108. As depicted, the surface 902 of the member 108 may be orthogonal to the surface 110.

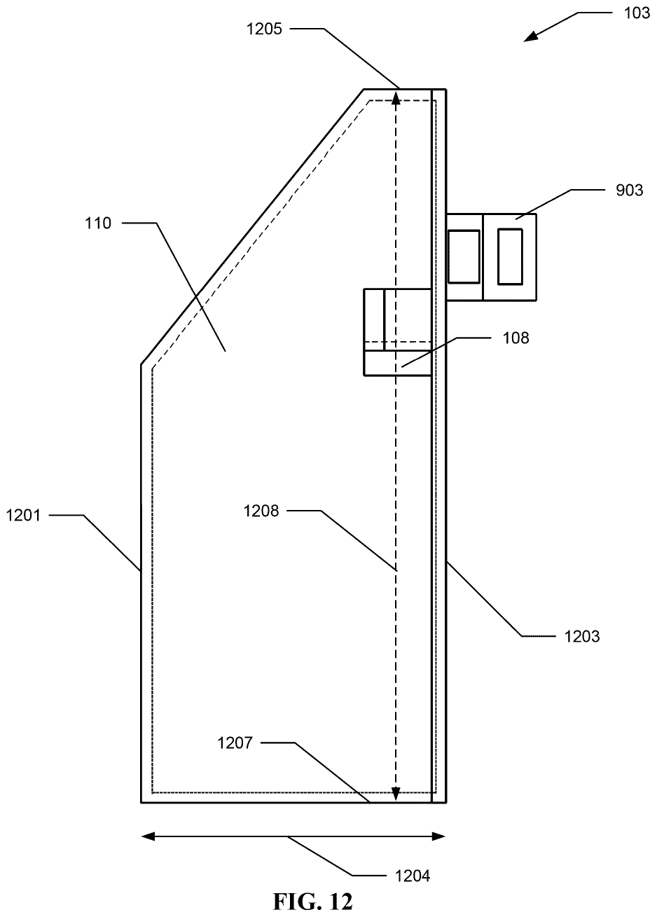

FIG. 12 provides a front view of a slide cover 103. For example, FIG. 12 depicts the surface 110, the member 903, and the member 108. In some embodiments, the slide cover 103 comprises a first edge 1201 and a second edge 1203 opposite the first edge 1201. In some embodiments, between the first edge 1201 and second edge 1203, the slide cover 103 comprises a width 1204 of 22.58-24.18. For example, the width 1204 may be 23.38 mm. In some embodiments, the slide cover 103 comprises a first end 1205 and a second end 1207 opposite the first end 1205. In some embodiments, between the first end 1205 and second end 1207, the slide cover 103 comprises a length 1208 of 53.37-54.97. For example, the length 1208 may be 54.17 mm. In some examples, the width 1204 and length 1208 may be greater than a width and length of an entry void of a dispensing chute.

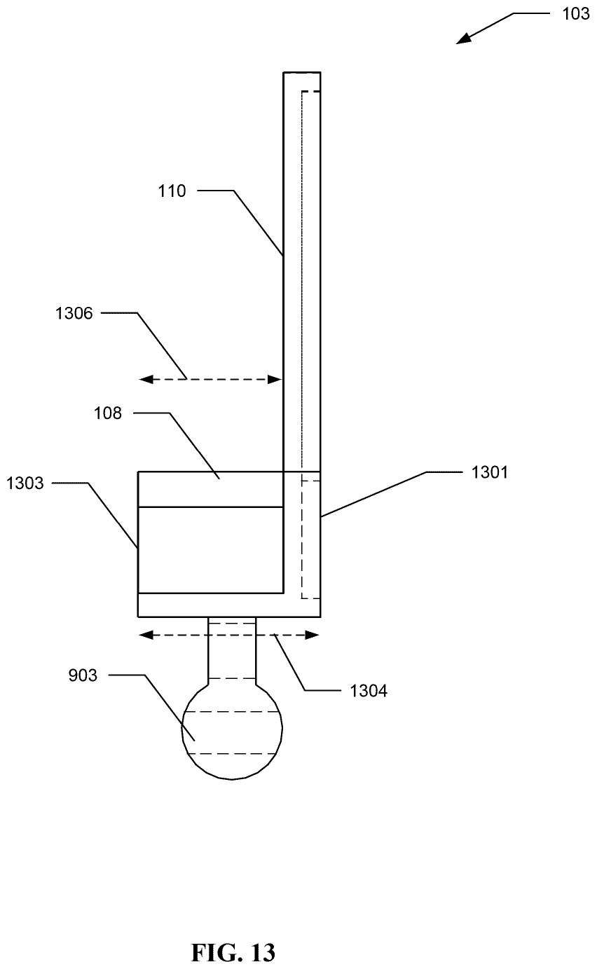

FIG. 13 provides a top view of a slide cover 103. For example, FIG. 13 depicts the member 903 and the member 908. In some embodiments, the slide cover 103 comprises a thickness 1304 between a bottom surface 1301 of the slide cover and a top surface 1303 of the member 108. In some embodiments, the thickness 1304 is 6.98-8.58. For example, the thickness 1304 may be 7.78 mm. In some embodiments, the member 108 comprises a height 1306 from the surface 110 to the top surface 1303. In some embodiments, the height 1306 is 4.39-11.30. For example, the member 108 may protrude from the surface 110 by 5.19 mm. As another example, the member 108 may protrude from the surface 110 by 6.17 mm. As another example, the member 108 may protrude from the surface by 10.50 mm.

### II. Example Chute Cover Operations

FIG. 14 shows a workflow 1400 for installing a chute cover mechanism 100. In some embodiments, the workflow 1400 comprises inserting the mechanism 100 over a dispensing chute 1401. In some embodiments, the workflow 1400 comprises attaching the chute cover 101 of the mechanism 100 to a rear portion 1402 of the dispensing chute 1401 via the first clip 109. In some embodiments, the workflow 1400 comprises attaching the chute cover 101 to a side portion 1404 via a second clip 201. In this manner, the slide cover 103 of the mechanism 100 may be centered over the entry void 1403 of the dispensing chute 1401 when the mechanism is configured to the engaged state. In some embodiments, when the mechanism 100 is installed, a top surface 1406 of the chute cover 101 is configured to be coplanar with a surface 1407 of a reservoir guide 1405. In various embodiments, the reservoir guide 1405 is configured to direct the insertion and removal of a dispensing reservoir.

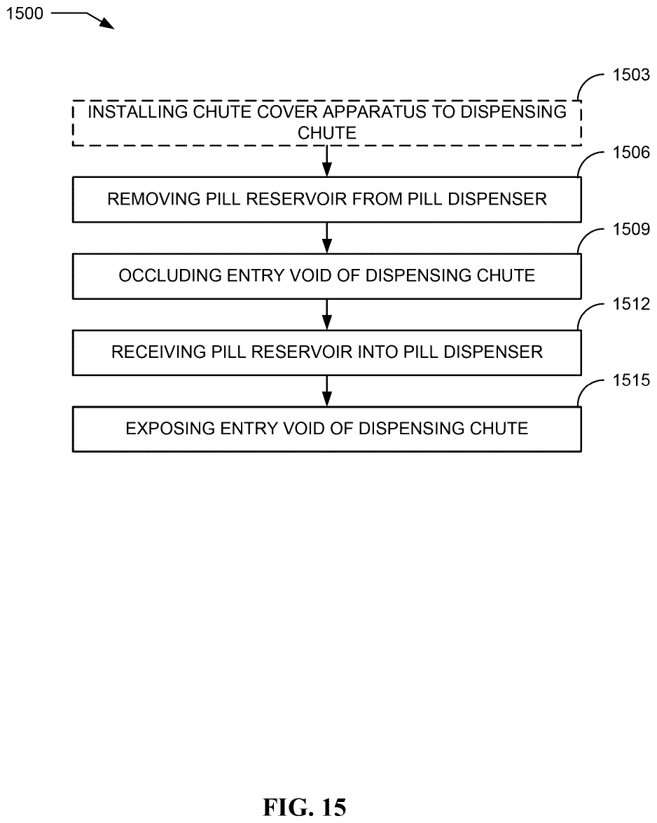

FIG. 15 is a flowchart of an example process for operating a chute cover mechanism 100. Although the example process 1500 depicts a particular sequence of steps/operations, the sequence may be altered without departing from the scope of the present disclosure. For example, some of the steps/operations depicted may be performed in parallel or in a different sequence that does not materially impact the function of the process 1500. In other examples, some of the steps/operations depicted may be omitted or combined in a manner that does not materially impact the function of the process 1500. In other examples, different components of an example device or system that implements the process 1500 may perform functions at substantially the same time or in a specific sequence. In some embodiments, a method of preventing objects from entering a dispensing chute is performed in accordance with one or more steps/operations of the process 1500.

In some embodiments, the process 1500 comprises, at step/operation 1503, installing the mechanism 100 to the dispensing chute of a dispenser. In some embodiments, installing the mechanism 100 comprises removing a dispensing reservoir from the dispenser to expose the dispensing chute. For example, a cannister may be unlocked and removed from a semi-automatic dispenser. In some embodiments, installing the mechanism 100 comprises removing one or more reservoir guides from the dispenser. For example, the reservoir guide may be detached and removed from the dispenser. In some embodiments, installing the mechanism 100 comprises attaching the chute cover 101 of the mechanism 100 to one or more portions of the dispensing chute via the first clip 109, the second clip 201, and/or the like, as further shown in FIG. 14 and described herein. In some embodiments, installing the mechanism 100 comprises reattaching the one or more reservoir guides and reinserting and locking the dispensing reservoir into the dispenser. In doing so, the mechanism 100 may be transitioned to a disengaged state such that the entry void of the dispensing chute is exposed and capable of receiving objects from the dispensing reservoir.

In some embodiments, the process 1500 comprises, at step/operation 1506, removing the dispensing reservoir from the dispenser. For example, the dispensing reservoir may be removed for refilling, cleaning, replacement, and/or the like. In some embodiments, the process 1500 comprises, at step/operation 1509, occluding the entry void of the dispensing chute via the installed mechanism 100. In various embodiments, the mechanism 100 transitions from a disengaged state to an engaged state as the dispensing reservoir is removed from the dispenser. For example, as the dispensing reservoir is withdrawn from the dispenser, the force of the dispensing reservoir upon the member 108 may be removed. The removal of the applied force may enable the bias force of the bias mechanism 105 to advance the member 903 along the slot 106. In doing so, the slide cover 103 may translate in a first direction over the entry void of the dispensing chute such that foreign objects are prevented from entering the entry void.

In some embodiments, the process 1500 comprises, at step/operation 1512 receiving a dispensing reservoir into the dispenser. The received dispensing reservoir may be the same reservoir removed at step/operation 1506 or a new dispensing reservoir. In some embodiments, the process 1500 comprises, at step/operation 1515 exposing the entry void of the dispensing chute. In various embodiments, the mechanism 100 transitions from the engaged state to the disengaged state as the dispensing reservoir is inserted into the dispenser. For example, as the dispensing reservoir is advanced in the dispenser, the member 108 may receive a force from the dispenser. The applied force may be greater than the bias force of the bias mechanism 105 such that the member 903 advances along the slot 106 and compresses the spring or magnetic arrangement therewithin (or stretch one or more elastic bands). In this manner, the slide cover 103 may translate in a second direction, opposite the first direction, such that the entry void of the dispensing chute is no longer occluded and may receive objects from the dispensing reservoir.

IV. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be comprised within the scope of the appended claims. Although specific terms are employed herein, they are used in a generic and descriptive sense only and not for purposes of limitation.

### V. Examples

Example 1. A chute cover mechanism for a dispenser, comprising: a chute cover comprising: a bias mechanism; a clip that attaches to a portion of the dispenser to position the chute cover over an entry void of a dispensing chute of the dispenser; and a channel positioned to receive a portion of a slide cover to constrain translation of the slide cover along a plane extending parallel to a surface of the chute cover; a top surface of the channel protruding from the surface of the chute cover to align the top surface of the channel with a top surface of a reservoir guide of the dispenser; the bias mechanism comprising a slot and a bias element within the slot; and the slide cover positioned within the channel and comprising a first member and a second member, the first member protruding from a first surface of the slide cover and positioned to receive a force from a dispensing reservoir to transition the chute cover mechanism from an engaged state to a disengaged state as the dispensing reservoir is inserted, via the reservoir guide, into the dispenser, and the second member protruding from a second surface of the slide cover and positioned within the slot to apply a force to the bias element as the dispensing reservoir is inserted into the dispenser, wherein: in the engaged state, the slide cover is positioned along the plane to at least partially cover the entry void of the dispensing chute; and in the disengaged state, the slide cover is positioned along the plane such that the entry void of the dispensing chute is exposed.

Example 2. The chute cover mechanism of Example 1, where the second member is positioned in the slot to receive a force from the bias element to transition the chute cover mechanism from the disengaged state to the engaged state as the dispensing reservoir is removed from the dispenser.

Example 3. The chute cover mechanism of Example 2, where the bias mechanism comprises a spring that receives the force from the second member as the dispensing reservoir is inserted into the dispenser and applies the force to the second member as the dispensing reservoir removed.

Example 4. The chute cover mechanism of Example 3, where the bias mechanism further comprises a retaining pin that attaches to the spring to anchor the spring within the slot.

Example 5. The chute cover mechanism of Example 2, where the bias element comprises a first magnetic element; the slot comprises a second magnetic element; and a side of the second magnetic element that faces a side of the first magnetic element comprises a polarity that matches a polarity of the side of the first magnetic element.

Example 6. The chute cover mechanism of Example 2, where the bias element comprises an elastic element attached within the slot.

Example 7. The chute cover mechanism of Example 1, where, to transition of the chute cover from the disengaged state, the slide cover translates along the channel, via the force from the bias element, to align the slide cover over the entry void of the dispensing chute.

Example 8. The chute cover mechanism of Example 1, where the second surface of the slide cover is orthogonal to the first surface of the slide cover.

Example 9. The chute cover mechanism of Example 1, where the chute cover and the slide cover comprise a food grade plastic material.

Example 10. The chute cover mechanism of Example 1, where a first clip protrudes from a first edge of the chute cover; the chute cover comprises second clip that protrudes from a second edge of the chute cover; and the first clip is positioned orthogonal to the second clip.

Example 11. The chute cover mechanism of Example 1, where, between a first end and a second end, the chute cover comprises a length of 101.5-103.13 mm.

Example 12. The chute cover mechanism of Example 1, where the chute cover comprises a bottom surface opposite the top surface of the channel; and a thickness of the chute cover between the top surface of the channel and the bottom surface of the chute cover is 20.69-22.29 mm.

Example 13. The chute cover mechanism of Example 1, where the chute cover comprises a first side surface opposite the clip and a second side surface between the first side surface and the clip; a first width of the chute cover between the first side surface and the clip is 58.32-59.92 mm; and a second width of the chute cover between the first side surface and the second side surface is 28.91-30.51 mm.

Example 14. The chute cover mechanism of Example 1, where the bias mechanism comprises a rectangular body protruding from the surface of the chute cover and comprising the slot and the bias element; and the slot comprises a circular cross-section.

Example 15. The chute cover mechanism of Example 1, where the slide cover comprises a first edge and a second edge opposite the first edge; and a width of the slide cover between the first edge and the second edge is 22.58-24.18 mm.

Example 16. The chute cover mechanism of Example 1, where a thickness of the slide cover between a bottom surface of the slide cover and a top surface of the first member is 6.98-8.58 mm.

Example 17. The chute cover mechanism of Example 1, where the slide cover comprises a first end and a second end opposite the first end; and between the first end and the second end, the slide cover comprises a length of 53.37-54.97 mm.

Example 18. The chute cover mechanism of Example 1, where a height of the first member, from the first surface of the slide cover, is 4.39-11.3 mm.

Example 19. A dispenser, comprising: a dispensing reservoir; a dispensing chute comprising an entry void that aligns with the dispensing reservoir when the dispensing reservoir is inserted into the dispenser along a reservoir guide; a chute cover mechanism that comprises: a chute cover comprising: a bias mechanism; a clip that attaches to a portion of the dispenser to position the chute cover over an entry void of a dispensing chute of the dispenser; and a channel positioned to receive a portion of a slide cover to constrain translation of the slide cover along a plane extending parallel to a surface of the chute cover; a top surface of the channel protruding from the surface of the chute cover to align the top surface of the channel with a top surface of a reservoir guide of the dispenser; the bias mechanism comprising a slot and a bias element within the slot; and the slide cover positioned within the channel and comprising a first member and a second member, the first member protruding from a first surface of the slide cover and positioned to receive a force from a dispensing reservoir to transition the chute cover mechanism from an engaged state to a disengaged state as the dispensing reservoir is inserted, via the reservoir guide into the dispenser, and the second member protruding from a second surface of the slide cover and positioned within the slot to apply a force to the bias element as the dispensing reservoir is inserted into the dispenser, wherein: in the engaged state, the slide cover is positioned along the plane to at least partially cover the entry void of the dispensing chute; and in the disengaged state, the slide cover is positioned along the plane such that the entry void of the dispensing chute is exposed.

Example 20. A method of integrating a chute cover mechanism, comprising a chute cover and a slide cover, within a dispenser, comprising: aligning a top surface of a channel protruding from a surface of the chute cover with a top surface of a reservoir guide of the dispenser; attaching a clip of the chute cover to a portion of the dispenser to position the chute cover and the slide cover over an entry void of a dispensing chute of the dispenser; and inserting a dispensing reservoir into the dispenser to exert a force onto the slide cover to translate the slide cover out of alignment with the entry void.

1. A chute cover mechanism for a dispenser, comprising:
a chute cover comprising:
a bias mechanism;
a clip that attaches to a portion of the dispenser to position the chute cover over an entry void of a dispensing chute of the dispenser; and
a channel positioned to receive a portion of a slide cover to constrain translation of the slide cover along a plane extending parallel to a surface of the chute cover;
a top surface of the channel protruding from the surface of the chute cover to align the top surface of the channel with a top surface of a reservoir guide of the dispenser;
the bias mechanism comprising a slot and a bias element within the slot; and
the slide cover positioned within the channel and comprising a first member and a second member, the first member protruding from a first surface of the slide cover and positioned to receive a force from a dispensing reservoir to transition the chute cover mechanism from an engaged state to a disengaged state as the dispensing reservoir is inserted, via the reservoir guide, into the dispenser, and the second member protruding from a second surface of the slide cover and positioned within the slot to apply a force to the bias element as the dispensing reservoir is inserted into the dispenser, wherein:
in the engaged state, the slide cover is positioned along the plane to at least partially cover the entry void of the dispensing chute; and
in the disengaged state, the slide cover is positioned along the plane such that the entry void of the dispensing chute is exposed.

2. The chute cover mechanism of claim 1, wherein:
the second member is positioned in the slot to receive a force from the bias element to transition the chute cover mechanism from the disengaged state to the engaged state as the dispensing reservoir is removed from the dispenser.

3. The chute cover mechanism of claim 2, wherein:
the bias mechanism comprises a spring that receives the force from the second member as the dispensing reservoir is inserted into the dispenser and applies the force to the second member as the dispensing reservoir removed.

4. The chute cover mechanism of claim 3, wherein:
the bias mechanism further comprises a retaining pin that attaches to the spring to anchor the spring within the slot.

5. The chute cover mechanism of claim 2, wherein:
the bias element comprises a first magnetic element;
the slot comprises a second magnetic element; and
a side of the second magnetic element that faces a side of the first magnetic element comprises a polarity that matches a polarity of the side of the first magnetic element.

6. The chute cover mechanism of claim 2, wherein:
the bias element comprises an elastic element attached within the slot.

7. The chute cover mechanism of claim 1, wherein:
to transition of the chute cover from the disengaged state, the slide cover translates along the channel, via the force from the bias element, to align the slide cover over the entry void of the dispensing chute.

8. The chute cover mechanism of claim 1, wherein:
the second surface of the slide cover is orthogonal to the first surface of the slide cover.

9. The chute cover mechanism of claim 1, wherein:
the chute cover and the slide cover comprise a food grade plastic material.

10. The chute cover mechanism of claim 1, wherein:
a first clip protrudes from a first edge of the chute cover;
the chute cover comprises second clip that protrudes from a second edge of the chute cover; and
the first clip is positioned orthogonal to the second clip.

11. The chute cover mechanism of claim 1, wherein:
between a first end and a second end, the chute cover comprises a length of 101.5-103.13 mm.

12. The chute cover mechanism of claim 1, wherein:
the chute cover comprises a bottom surface opposite the top surface of the channel; and
a thickness of the chute cover between the top surface of the channel and the bottom surface of the chute cover is 20.69-22.29 mm.

13. The chute cover mechanism of claim 1, wherein:
the chute cover comprises a first side surface opposite the clip and a second side surface between the first side surface and the clip;
a first width of the chute cover between the first side surface and the clip is 58.32-59.92 mm; and
a second width of the chute cover between the first side surface and the second side surface is 28.91-30.51 mm.

14. The chute cover mechanism of claim 1, wherein:
the bias mechanism comprises a rectangular body protruding from the surface of the chute cover and comprising the slot and the bias element; and
the slot comprises a circular cross-section.

15. The chute cover mechanism of claim 1, wherein:
the slide cover comprises a first edge and a second edge opposite the first edge; and
a width of the slide cover between the first edge and the second edge is 22.58-24.18 mm.

16. The chute cover mechanism of claim 1, wherein:
a thickness of the slide cover between a bottom surface of the slide cover and a top surface of the first member is 6.98-8.58 mm.

17. The chute cover mechanism of claim 1, wherein:
the slide cover comprises a first end and a second end opposite the first end; and
between the first end and the second end, the slide cover comprises a length of 53.37-54.97 mm.

18. The chute cover mechanism of claim 1, wherein:
a height of the first member, from the first surface of the slide cover, is 4.39-11.3 mm.

19. A dispenser, comprising:
a dispensing reservoir;
a dispensing chute comprising an entry void that aligns with the dispensing reservoir when the dispensing reservoir is inserted into the dispenser along a reservoir guide;
a chute cover mechanism that comprises:
a chute cover comprising:
a bias mechanism;
a clip that attaches to a portion of the dispenser to position the chute cover over an entry void of a dispensing chute of the dispenser; and
a channel positioned to receive a portion of a slide cover to constrain translation of the slide cover along a plane extending parallel to a surface of the chute cover;
a top surface of the channel protruding from the surface of the chute cover to align the top surface of the channel with a top surface of a reservoir guide of the dispenser;
the bias mechanism comprising a slot and a bias element within the slot; and
the slide cover positioned within the channel and comprising a first member and a second member, the first member protruding from a first surface of the slide cover and positioned to receive a force from a dispensing reservoir to transition the chute cover mechanism from an engaged state to a disengaged state as the dispensing reservoir is inserted, via the reservoir guide into the dispenser, and the second member protruding from a second surface of the slide cover and positioned within the slot to apply a force to the bias element as the dispensing reservoir is inserted into the dispenser, wherein:
in the engaged state, the slide cover is positioned along the plane to at least partially cover the entry void of the dispensing chute; and
in the disengaged state, the slide cover is positioned along the plane such that the entry void of the dispensing chute is exposed.

20. A method of integrating a chute cover mechanism, comprising a chute cover and a slide cover, within a dispenser, comprising:
aligning a top surface of a channel protruding from a surface of the chute cover with a top surface of a reservoir guide of the dispenser;
attaching a clip of the chute cover to a portion of the dispenser to position the chute cover and the slide cover over an entry void of a dispensing chute of the dispenser; and
inserting a dispensing reservoir into the dispenser to exert a force onto the slide cover to translate the slide cover out of alignment with the entry void.
